(19) United States
(12) Patent Application Publication
(10) Pub. No.: US 2008/0198721 A1
(43) Pub. Date: Aug. 21, 2008

(54) Method of Recording Data on a Dual-Layer Optical Write-Once Disc

(75) Inventor: Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,573

(22) PCT Filed: Apr. 13, 2006
(86) PCT No.: PCT/IB2006/051163

§ 371 Date: Oct. 15, 2007

(30) Foreign Application Priority Data
Apr. 21, 2005 (EP) 05103242.3

(51) Int. Cl. G11B 3/74

(52) U.S. Cl. 369/94

(57) ABSTRACT

The present invention relates to a method of recording data on a dual-layer optical write-once disc (10), comprising the steps of:
creating a first-layer video-data fragment (28) on a first layer (20) of the optical disc, the first-layer video-data fragment extending from a minimum first-layer video-data radius within a data zone of the disc to an outer radius within the data zone of the disc, the outer radius defining a layer boundary (38), creating a second-layer video-data fragment (40) on a second layer (22) of the optical disc, the second-layer video-data fragment extending from minimum second-layer video-data radius within the data zone of the disc to the layer boundary,
writing video data (32) to the first-layer video-data fragment, starting from an inner radius of the disc up to a maximum first-layer video-data radius smaller than or equal to the layer boundary,
writing video data to the second-layer video-data fragment, starting from the layer boundary, and
if the maximum first-layer video-data radius is smaller than the layer boundary, writing a Buffer Cell (66) to the first-layer video-data fragment extending from the maximum first-layer video-data radius to the layer boundary.

The present invention further elates to a dual-layer optical disc and an apparatus for recording data on a dual-layer optical disc.

### FIELD OF THE INVENTION

The present invention relates to a method of recording data on a dual-layer optical disc. Particularly, the invention relates to a method of recording data on dual-layer write-once (R) data carriers to render them mutually compatible with dual-layer repetitive read/write (RW) data carriers, for example for data copying purposes. Moreover, the invention relates to a dual-layer optical disc and to an apparatus for recording data on a dual-layer optical disc.

### BACKGROUND OF THE INVENTION

Various standards have been defined in order to ensure the compatibility of DVD data carriers and DVD apparatus. One of the issues of those standards is the compatibility between DVD+R and DVD+RW. By making recordable discs (DVD+R) compliant to repetitive read-write discs (DVD+RW), a copy of the finalized DVD+R disc on a DVD+RW disc can be edited on the basis of the common standard for DVD+RW.

The DVD+R video format specifications were extended to accommodate video recording on a dual-layer recordable disc. One of the issues discussed is the layer jump. The mentioned specifications prescribes that the location of the layer boundary, i.e. the border between the user data zone on the disc and an outer region of the disc—the “middle zone”—has not been fixed until the video recording actually starts using the second layer, i.e. the layer behind the first layer as viewed in the direction of the writing or reading laser beam. This requirement makes it easier for the video recording application to align Cells in the video file with the layer boundary, this alignment being a requirement from the DVD video specifications. As perfect alignment is usually not possible or at least difficult to achieve, a Buffer Cell has to be added on the first layer. The second layer then starts with a new Cell. The Buffer Cell is not included in the program chain (PGC) which contains a list of the Cells included in the play back.

FIG. 5 illustrates the previously described concept. A portion of a cross section perpendicular to the surface of a dual-layer DVD+R disc 110 is shown. The disc 110 comprises a first layer 120 (L0) and a second layer 122 (L1). A layer boundary 138 separates the first layer 120 and the second layer 122 from the middle zone 118. The arrow 162 illustrates the radial writing direction when writing on the first layer 120. The arrow 164 illustrates the radial writing direction when writing on the second layer 122. Considering these writing directions 162, 164, which correspond to the respective playback directions, clarifies the term “middle zone”: Although the data zone is available on two layers 120, 122, the user, i.e. the application, “sees” this as on logically consecutive recording area. Thus, the area 118 is called “middle zone”. Both layers 120, 122 are divided into Cells 154, 156, 158, 160. Considering the radial writing direction, the Cells are written in a consecutive manner, i.e. Cell 154 is Cell number n−1, Cell 156 is Cell number n, Cell 158 is Cell number n+1, Cell 160 is Cell number n+2. In addition to the mentioned Cells 154, 156, 158, 160, a Buffer Cell 166 is written on the first layer 120 in order to fill up the first layer up to the layer boundary 138.

In order to allow for intermittently storing video and data files it has been proposed to define separate fragments for “video” and “data”. On a dual-layer disc, the start of the data fragment is typically located on the second layer to allow for enough space for the video content. According to the DVD+R dual-layer basic format specification, the position of the layer boundary can be defined at any time as long as no data has been written on the second layer. At the moment that the data fragment is defined on the second layer, the position of the layer boundary must be fixed. Now, the video recording application loses the advantage that it can determine where the layer jump can be done. It has to make sure the Cell is complete on the first layer before the boundary is reached, stuff the first layer up to the boundary by inserting a Buffer Cell and then start writing the next Cell on the second layer. As the end of a Cell is not easily predicted due to variable bit rate encoding, the amount of stuffing can be substantial. This is an undesired situation as the jump must be done as fast as possible to avoid video buffer overflow.

The following references are part of the background of the present invention:

Hewlett-Packard, Mitsubishi Chemical, Philips, Ricoh, Sony, Yamaha: DVD+R 8.5 Gbytes Basic Format Specifications (Version 0.9, December 2003).

Royal Philips Electronics: DVD+RW Video Format Specifications (Version 2.0, October 2003).

Royal Philips Electronics: DVD+R Video Format Specifications (Preliminary Version 1.9, January 2004).

DVD Specifications for Read-Only Disc—Part 3: Video Specifications (Version 1.1, December 1997, including supplemental information up to January 2001).

It is an object of the invention to provide a method of recording data on a dual-layer optical disc on basis of which the layer jump during recording can be performed on a short time scale.

### SUMMARY OF THE INVENTION

The above objects are solved by the features of the independent claims. Further developments and preferred embodiments of the invention are outlined in the dependent claims.

In accordance with the invention, there is provided a method of recording data on a dual-layer write-once optical disc, comprising the steps of:
creating a first-layer video-data fragment on a first layer of the optical disc, the first-layer video-data fragment extending from a minimum first-layer video-data radius within a data zone of the disc to an outer radius within the data zone of the disc, the outer radius defining a layer boundary,
creating a second-layer video-data fragment on a second layer of the optical disc, the second-layer video-data fragment extending from minimum second-layer video-data radius within the data zone of the disc to the layer boundary,
writing video data to the first-layer video-data fragment, starting from an inner radius of the disc up to a maximum first-layer video-data radius smaller than or equal to the layer boundary,
writing video data to the second-layer video-data fragment, starting from the layer boundary, and
if the maximum first-layer video-data radius is smaller than the layer boundary, writing a Buffer Cell to the first-layer video-data fragment extending from the maximum first-layer video-data radius to the layer boundary.

Thus, the writing of the Buffer Cell is delayed until the video recording is completed. Because this is not possible when the video-data fragment is extended over the layer boundary, two video data fragments are provided, a first-layer video-data fragment on the first layer and a second-layer video-data fragment on the second layer. The boundary between the fragments is exactly at the layer boundary. The layer jump can now be carried out immediately after the last Cell on the first layer has been written. The next Cell is then written to the second-layer video-data fragment. After the video recording is completed, the first-layer video-data fragment is completed by writing the Buffer Cell up to the end of the fragment.

According to a preferred embodiment of the present invention, the method further comprises the step of creating a first-layer organizing-data fragment on the first layer at radii smaller than the minimum radius of the first-layer video-data fragment. This first-layer organizing-data fragment is dedicated for storing organizing-data to the disc after the video recording has been finished, e.g. file system information, DVD video database files, i.e. information files that are also known as ifo-files, and a DVD menu. The DVD video format requires that this data is recorded in front of the video data.

In this context, the present invention further comprises the step of writing organizing data to the first-layer organizing-data fragment during finalizing the recording.

According to a still further aspect of the present invention, the method further comprises the step of creating a second-layer data fragment on the second layer at radii smaller than the minimum radius of the second-layer video-data fragment. This second-layer data fragment is reserved for the data section, e.g. for storing JPEG files. According to the DVD+R 8.5 Gbytes Basic Format Specifications this “data section” is also called the “incomplete fragment”.

In this context the present invention further comprises the step of writing data files other than video data to the second-layer data fragment.

According to a still further aspect of the present invention, the method comprises the steps of:
during writing video data to the first-layer video-data fragment, monitoring the size of a next data unit to be written, and
in case that the size of the next data unit to be written exceeds an unwritten space of the first-layer video-data fragment, continuing writing video data to the second-layer video-data fragment.

A Cell in the DVD+RW Video format has the size of about 36 MB. It consist of a sequence of VOBUs (Video Object Units), each representing between 0.4 and 1 second of video. The number of VOBUs in a Cell depends on the bit rate, which is usually variable, aiming at a constant picture quality. In this sense, the size of the next VOBU is monitored in order to not exceed the size of the first-layer video-data fragment. The free space remaining on the first-layer video-data fragment is filled up by a Buffer Cell after finishing the video recording on the second layer.

In accordance with the invention, there is further provided a dual-layer optical disc including video data and other data recorded thereon according to the method of the invention.

In accordance with the invention, there is still further provided an apparatus for recording data on a dual-layer optical disc, said apparatus being arranged to write data on the data carrier according to the method of the invention.

These and other aspects of the invention will be apparent from and elucidated with reference to the embodiments described hereinafter.

### BRIEF DESCRIPTION OF THE DRAWINGS

FIG. 1 schematically illustrates a cross section of a dual-layer DVD+R disc having various partitions and data recorded on the disc.

FIG. 2 illustrates a cross section of a dual-layer optical disc according to the present invention.

FIG. 3 illustrates an apparatus according to the present invention.

FIG. 4 shows a flow chart for illustrating a method according to the present invention.

FIG. 5 illustrates a cross section of a dual-layer optical disc according to prior art.

### DESCRIPTION OF PREFERRED EMBODIMENTS

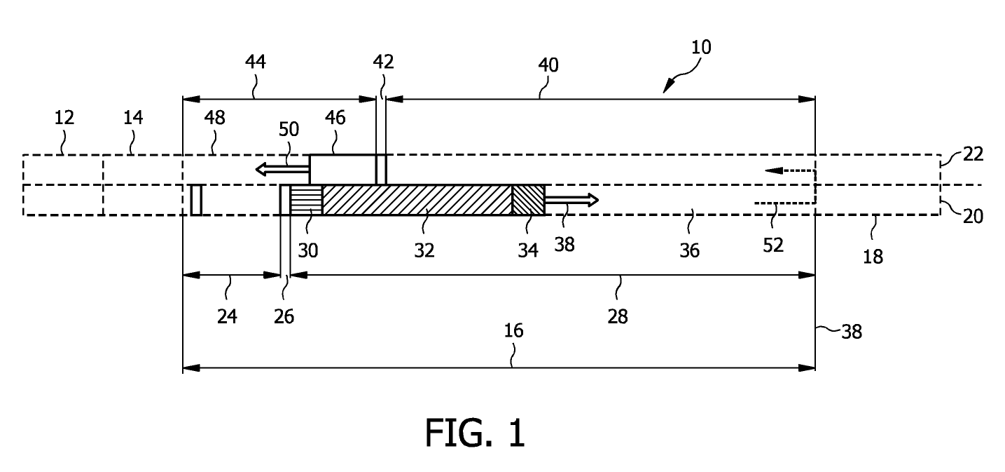

FIG. 1 schematically illustrates a cross section of a dual-layer DVD+R disc having various partitions and data recorded on the disc. The dual-layer optical disc 10 comprises an inner drive area 12, followed by a lead-in zone 14. Radially outward from the lead-in zone 14, the data zone 16 is located, followed by the middle zone 18. All of the mentioned zones are divided into a first layer 20 and a second layer 22. The data zone 16 is further partitioned. Starting from the border of the data zone 16 to the lead-in zone 14, in writing direction, the data zone comprises one, two or even more reserved fragments 24. These fragments are used after the video recording for storing organizing-data. In the currently used DVD+R video format, the reserved area consists of just one reserved fragment. If there is a separate fragment for data, this is still possible. However, the data fragment contains file system data, possibly using elements from the UDF 1.5 standard. The advantage of this would be that the disc could be read on a PC. In the case of a recordable disc in intermediate state, some data (AVDP) shall be recorded at sector 512. See UDF 1.5 section 6.10.1. Actually 16 sectors shall be written as this is the minimum recordable unit on a DVD+R disc. Data can only be written within the reserved area, if it is from the beginning of a fragment. Therefore the reserved area needs to be split in a 1st fragment before sector 512, and a 2nd fragment from 512 onwards. Comparable reasons can make the use of more than two fragments advisable. Except for the first fragment on each layer that have run-in areas in the lead-in zone and the middle zone, all reserved fragments are preceded by small run-in zones. The run-in zone 26 is followed by a first-layer video-data fragment 28. The first-layer video-data fragment 28 comprises a buffer 30, video and file system data 32 and a RSAT area 34. The RSAT area 34 is provided for a reserved space allocation table (RSAT). RSAT is described in a published United States patent application No. US2003/0068159 which is hereby incorporated by reference with regard to RSAT. The RSAT area 34 is followed by an unrecorded portion 36 of the first-layer video-data fragment 28 up to the layer boundary 38. Further video data will be appended by using this unrecorded portion 36, as indicated by the arrow 38. During writing video data to the first-layer video-data fragment, the size of the next VOBU is monitored. In case that the size of the next VOBU to be written exceeds or is estimated to exceed the unrecorded portion of the first-layer video-data fragment, the recording continues on the second layer 22. For this purpose, a second-layer video-data fragment 40 is provided on the second layer 22. Following the second-layer video-data fragment 40, a run-in zone 42 is provided. The run-in zone 42 is followed by a second-layer data fragment 44, the so-called incomplete fragment. Data 46 are written to the second-layer data fragment 44, and further data files are appended to the unrecorded portion 48 of the second-layer data fragment 44, as indicated by the arrow 50. Additional fragments following the second-layer video-data fragment can be provided. By defining the first-layer video-data fragment 28 and the second-layer video-data fragment 40 such that the layer boundary 38 is just between these two fragments 28, 40, the layer jump, as indicated by the arrow 52, can be performed immediately after finishing the video recording on the first layer 20; there is no need to “interrupt” the video recording for writing a Buffer Cell up to the layer boundary 38, and the video recording may be immediately continued on the second layer 22. The Buffer Cell for filling up the first layer 20 can be written after the video recording on the second layer 22 has been finished.

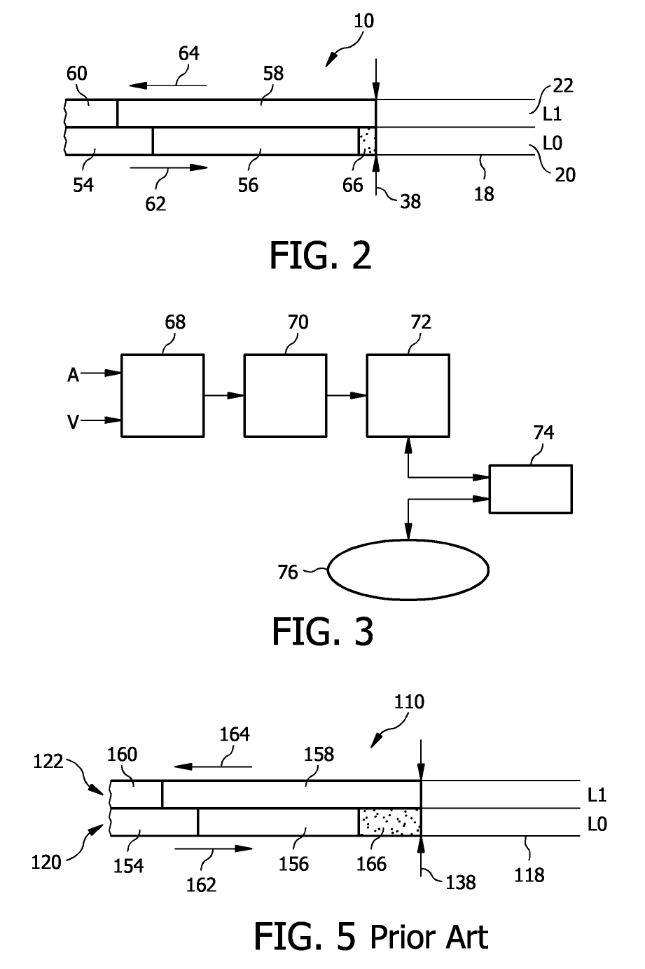

FIG. 2 illustrates a dual-layer optical disc according to the present invention. The Cells 54, 56, 58, 60 have been written sequentially in the direction of the arrows 62, 64, while the Buffer Cell 66 has been written after finishing the video recording. Thus, as a result of the recording process, the dual-layer disc 10 according to FIG. 2 has the same Cell structure as the previously described prior art dual-layer disc 110 according to FIG. 5. As an example, the Buffer Cell 66 according to FIG. 2 is smaller than the buffer Cell 166 according to FIG. 5. This is to illustrate that the size of the Buffer Cell varies in dependence on the position of the layer boundary and the size of the variable length Cells on the first layer.

FIG. 3 illustrates an apparatus according to the present invention. The schematic illustration of a PC (personal computer) or a CE (consumer electronics) device with DVD+R/RW drive with support for dual-layer DVD+R discs comprises an A/V encoder 68 into which audio (A) and video (V) data are input. Further, a multiplexer/formatter is provided to combine the real-time audio and video streams and add the necessary headers and meta data according to the DVD+RW Video format. A video buffer 72 is provided for receiving data from the multiplexer/formatter 70. The video buffer 72 communicates with a data handler 74. The data handler 74 also communicates with a disc drive 76. The interface between the data handler 24 and the disc drive 76 is preferably an IDE (integrated device electronics) interface with MMC (multi-media command set) commands for control and the read/write data.

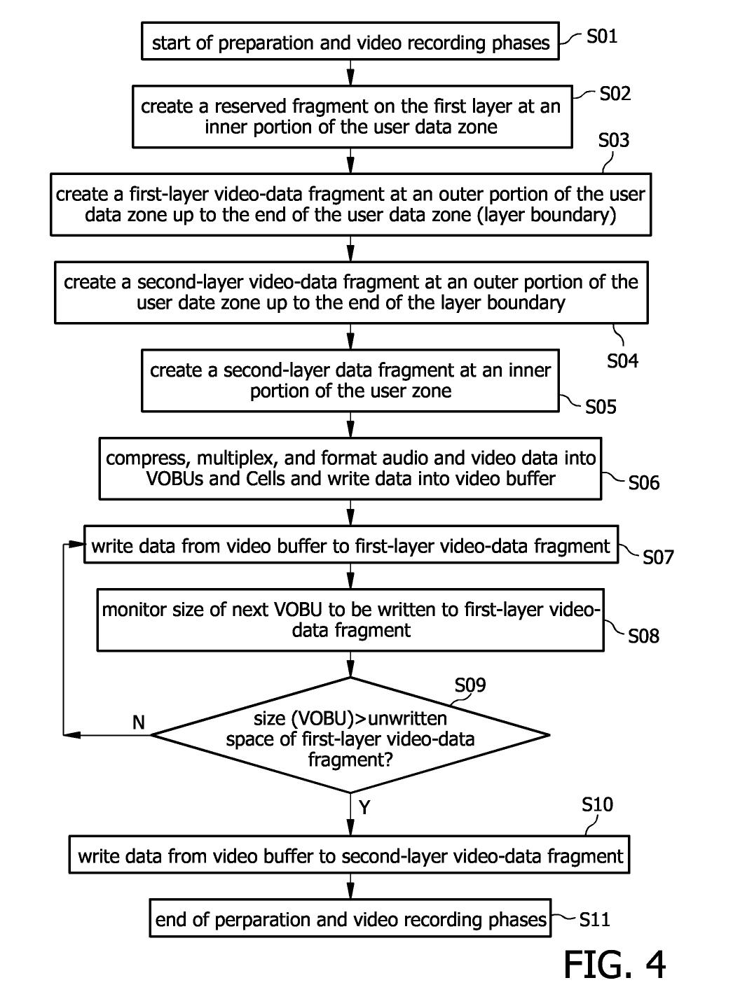

FIG. 4 shows a flow chart for illustrating a method according to the present invention. In presence of a DVD+R disc in the drive with data on the DVD+R disc laid out according to the DVD+R/RW video format the preparation and video recording phases start in step S01. First, the preparation takes place by creating a reserved fragment (track) at an inner portion of the user data zone, preferably at a start of the user data zone of the DVD+R disc. In a next step S03, a first-layer video-data fragment at an outer portion of the user data zone is created up to the end of the user data zone, i.e. up to the layer boundary. In step S04 a second-layer video-data fragment is created at an outer portion of the user data zone up to the end of the layer boundary. In step S05 a second-layer data fragment at an inner portion of the user data zone is created, the so-called incomplete fragment. The sequence of the steps S02, S03, S04 and S05 which constitute the preparation phase can be varied. After the preparation phase the video recording phase starts in step S06. Video data is compressed, multiplexed and formatted into VOBUs and Cells according to the DVD+RW video format. The output is continuously fed into the video buffer. According top step S07 data is written from the video buffer to the first-layer video-data fragment. According to step S08, the data handler monitors the fullness of the video buffer and writes data to the first-layer video-data fragment on the disc as soon as a certain fullness level of the video buffer is reached. The rate of writing data to the disc is at least the double of the bit rate of the multiplexed stream. Typically, the write speed of a dual layer disc is 2.4×11.08 Mbps. The bit rate of the multiplexed stream is variable with a maximum of 10.08 Mbps. When approaching the end of the first layer, the data handler takes into account the maximum size of a VOBU (i.e. ˜10 Mb in case of 1 second VOBUs) according to step S09. When less than the maximum size of a VOBU is left at the end of a certain VOBU, the next Cell will not be written to the first-layer video-data fragment but to the second-layer video-data fragment which is located on the second layer according to step S10. Writing continues at the second layer until the end of the video recording (S11).

After the video recording the disc updating phase starts. In one step, the Buffer Cell is appended to the first-layer video-data fragment for padding up to the end of the first layer. In another step data is appended to the second-layer data fragment, particularly DVD menu and information files, DVD+RW Video files (video recoding management information (VRMI), including backup), file system data, RSAT. The order of steps during the disc updating phase may vary.

After the updating phase, the finalization is initiated by the user when he decides not to add any more recordings to the disc.

Equivalents and modifications not described above may also be employed without departing from the scope of the invention, which is defined in the accompanying claims.

1. A method of recording data on a dual-layer optical write-once disc (10), comprising the steps of:
creating a first-layer video-data fragment (28) on a first layer (20) of the optical disc, the first-layer video-data fragment extending from a minimum first-layer video-data radius within a data zone of the disc to an outer radius within the data zone of the disc, the outer radius defining a layer boundary (38),
creating a second-layer video-data fragment (40) on a second layer (22) of the optical disc, the second-layer video-data fragment extending from minimum second-layer video-data radius within the data zone of the disc to the layer boundary,
writing video data (32) to the first-layer video-data fragment, starting from an inner radius of the disc up to a maximum first-layer video-data radius smaller than or equal to the layer boundary,
writing video data to the second-layer video-data fragment, starting from the layer boundary, and
if the maximum first-layer video-data radius is smaller than the layer boundary, writing a Buffer Cell (66) to the first-layer video-data fragment extending from the maximum first-layer video-data radius to the layer boundary.

2. The method according to claim 1, further comprising the step of creating a first-layer organizing-data fragment (24) on the first layer (20) at radii smaller than the minimum radius of the first-layer video-data fragment (28).

3. The method according to claim 2, further comprising the step of writing organizing data to the first-layer organizing-data fragment (24) during finalizing the recording.

4. The method according to claim 1, further comprising the step of creating a second-layer data fragment (44) on the second layer (22) at radii smaller than the minimum radius of the second-layer video-data fragment (40).

5. The method according to claim 4, further comprising the step of writing data (46) files other than video data to the second-layer data fragment (44).
The method according to claim 1, further comprising the steps of:
during writing video data to the first-layer video-data fragment (28), monitoring the size of a next data unit to be written, and
in case that the size of the next data unit to be written exceeds an unwritten space of the first-layer video-data fragment, continuing writing video data to the second-layer video-data fragment (40).

7. A dual-layer optical disc including video data and other data recorded thereon according to the method of claim 1.

8. An apparatus for recording data on a dual-layer optical disc, said apparatus being arranged to write data on the data carrier according to the method of claim 1.
